(19) United States
(12) Patent Application Publication
(10) Pub. No.: US 2025/0128453 A1
(43) Pub. Date: Apr. 24, 2025

(54) PRE-SHAPED SPACE FILLERS FOR SMALL CROSS SECTION FEATURES

(71) Applicant: RTX Corporation, Farmington, CT (US)

(72) Inventors: Kathryn S. Read, Marlborough, CT (US); Shaun M. Enos, Vernon, CT (US); Robin H. Fernandez, East Haddam, CT (US); Howard J. Liles, Newington, CT (US); Christian X. Campbell, West Hartford, CT (US); Raymond Surace, Newington, CT (US); John D. Riehl, Hebron, CT (US); Morgan Lowery, Amston, CT (US); Peter J. Rosenfeld, Westport, MA (US)

(21) Appl. No.: 18/493,599

(22) Filed: Oct. 24, 2023

(51) Int. Cl. B29B 11/16; B29K 229/00; B29K 309/04; C04B 35/628; C04B 35/64; C04B 35/657; C04B 35/80; F02C 7/00

(52) U.S. Cl. CPC B29B 11/16; C04B 35/62863; C04B 35/62884; C04B 35/62886; C04B 35/62894; C04B 35/64; C04B 35/657; C04B 35/80; B29K 2229/04; B29K 2309/04; C04B 2235/5244; C04B 2235/5256; C04B 2235/614; C04B 2235/616; F02C 7/00

(57) ABSTRACT

A method of fabricating a variable geometry space filling insert for a ceramic matrix composite component includes arranging a plurality of fiber bodies into a preform insert, applying a polymer binder to the plurality of fiber bodies, trimming at least a first subset of the plurality of fiber bodies such that each of the first subset of fiber bodies is shorter than at least a second subset of fiber bodies, shaping the insert with a forming tool to form a shaped insert.

### BACKGROUND

The present invention relates to ceramic matrix composites and, more particularly, space filling inserts for use in ceramic matrix composite preforms.

Many ceramic matrix composite (CMC) components for gas turbine engines have open spaces between plies due to complex geometries. Some of these spaces are too small to form with textile-based plies, but too large to form using individual fiber tows. In such cases, space filling inserts can be used to build upon and prevent large voids in the body of the CMC. These spaces themselves can be complexly shaped, for example, having non-constant geometries in one or more directions. Accordingly, means for optimizing space filling inserts to fill these spaces are desirable.

### SUMMARY

A method of fabricating a variable geometry space filling insert for a ceramic matrix composite component includes arranging a plurality of fiber bodies into a preform insert, applying a polymer binder to the plurality of fiber bodies, trimming at least a first subset of the plurality of fiber bodies such that each of the first subset of fiber bodies is shorter than at least a second subset of fiber bodies, shaping the insert with a forming tool to form a shaped insert.

A variable geometry space filling insert for use in a ceramic matrix composite component includes a plurality of fiber bodies in a bundle, the bundle including a first subset of fiber bodies, and a second subset of fiber bodies, each being longer than each of the first subset of fiber bodies.

### BRIEF DESCRIPTION OF THE DRAWINGS

FIG. 1 is a simplified perspective view of a preform with a triangular space filling insert.

FIG. 2 is a simplified perspective view of the insert of FIG. 1, showing its non-constant cross-sectional geometry as a function of location along its length.

FIGS. 3A, 3B, and 3C are simplified side views of alternative preform insert fiber arrangements.

FIG. 3D is a simplified cross-sectional view of a preform insert with sacrificial polymer yarns.

FIG. 4 is a flowchart illustrating select steps of a method for fabricating a space filling insert for a preform.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

This disclosure presents various space filling inserts, sometimes referred to as “noodles,” for incorporation into a CMC preform. These inserts can be advantageously pre-shaped to the dimensions of non-uniform open spaces within a preform.

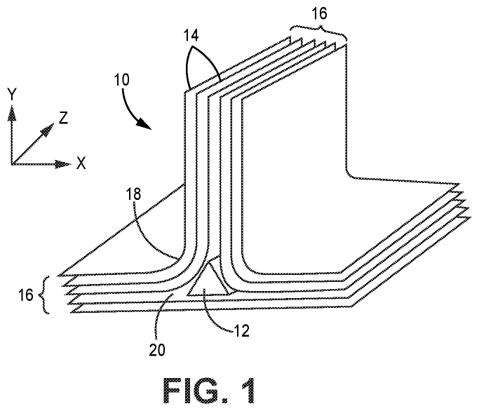

FIG. 1 is a simplified perspective view of preform 10 with space filling insert 12. Preform 10 can be used to form a CMC component for use in a gas turbine engine combustor, compressor, and/or turbine section, to name a few non-limiting examples. Preform 10 is formed from multiple plies 14 laid up in such a manner as to form a structure with a desired shape and thickness. Plies 14 can be formed from braided, woven, and/or chopped ceramic fibers or tows. The ceramic material can be silicon carbide (SiC) or another suitable ceramic material. As shown in FIG. 1, plies 14 can be laid up to form walls 16 with curved regions 18. The bending of plies 14 to form curved region 18 can create a void 20 between a subset of plies 14. Void 20 can be too small to effectively fill with additional plies 14. Thus, insert 12 can be formed to have a shape and size generally complementary to void 20. More specifically, insert 12 can be formed to have a complementary triangular cross-sectional geometry, a thickness or width defined in one or a combination of the x and y-axes, and a length extending along the z-axis. Generally speaking, insert 12 is sized and shaped to fill void 20 along the x, y, and z-axes. Other cross-sectional geometries (e.g., rectangular, rounded, curvilinear, etc.) are contemplated herein as appropriate to the geometry of void 20. In some cases, void 20 can have a non-constant (i.e., variable) cross-sectional geometry as a function of location along its length, for example, tapering in the direction of the z-axis, so a similarly shaped insert 12 is necessary to complement the geometry of void 20. Such voids can be found, for example, in airfoil preforms with variably shaped cavities (e.g., trailing edge cavities) in the spanwise (i.e., z-axis) direction.

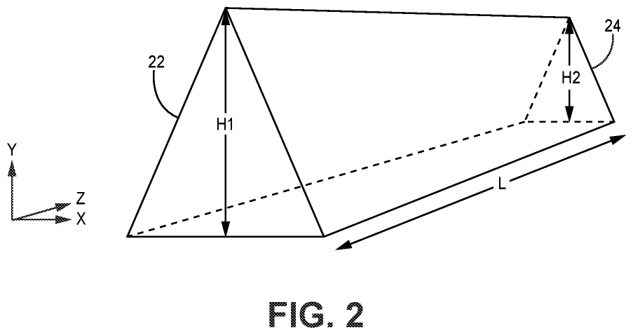

FIG. 2 is a simplified perspective view of insert 12 shown with a variable cross-sectional geometry. More specifically, insert 12, as shown, tapers along its length L in the x and y-directions, such that the area defined by the x-y plane is greater at first end 22 than at second end 24. For example, height H1 at first end 22 and height H2 at second end are shown, and H1 is greater than H2. In an alternative embodiment, insert 12 can taper from first end 22 toward its center and widen from the center towards second end 24. Insert 12 can also vary in other ways, such as non-linearly or along a single axis, including a change in shape, to name a few non-limiting examples.

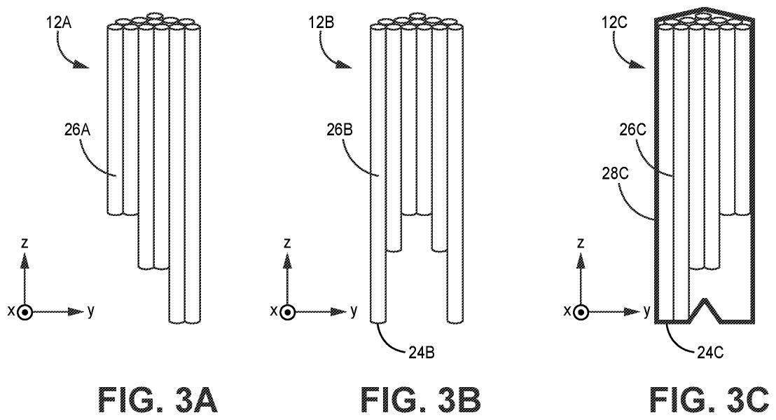

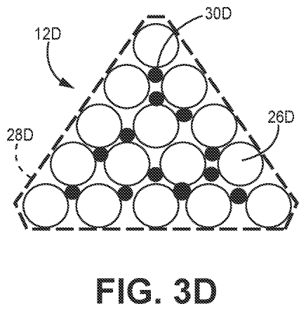

FIGS. 3A, 3B, and 3C are simplified side views of preform inserts 12A, 12B, and 12C with differing arrangements of variously sized fiber bodies 26A, 26B, and 26C (collectively referred to as “fiber bodies 26”), respectively, for creating an insert having a variable cross-sectional geometry (e.g., insert 12). Individual fiber bodies 26 can, in one example, be tows of bundled ceramic (e.g., Nicalon™ SiC) fibers. In an alternative embodiment, each fiber body 26 can instead be a strand of braided tows. Such strands can be formed of braided tows or bundles of twisted pairs of tows. Preform inserts 12A-12C (as well as 12D discussed below) are those which are in process and have not yet been incorporated into the greater preform (e.g., preform 10).

In FIG. 3A, preform insert 12A has a stepped arrangement of fiber bodies 26A increasing in length (i.e., dimension along the z-axis) from left to right based on the depicted orientation of preform insert 12A. In FIG. 3B, preform insert 12B has a mirrored arrangement such that the longest fiber bodies 26B are along the periphery of preform insert 12B, and the length decreases for each fiber body 26B moving toward the center of preform insert 12B. In such an embodiment, the longest fiber bodies 26B can be pinched together at second end 24B to achieve a tapered shape similar to insert 12. In FIG. 3C, preform insert 12C has a sheathed arrangement such that fabric sheath 28C is disposed around fiber bodies 26C to form the outermost surface of preform insert 12C. Sheath 28C can be formed of one or more small fibrous ceramic plies which can be woven or braided in some embodiments. Sheath 28C need not fully circumscribe fiber bodies 26C in all embodiments. Fiber bodies 26C within sheath 28C have various lengths. Like preform insert 12B, sheath 28C can be pinched together at second end 24C to achieve a tapered shape. A similar fabric sheath can be used with inserts 12A and/or 12B and can generally help maintain the respective bundled fiber bodies 26 held within. In any of the foregoing embodiments, there can be up to eight different fiber body lengths in a given preform insert.

FIG. 3D is a simplified cross-sectional view of the fiber arrangement of preform insert 12D, which can have an arrangement of any of preform inserts 12A, 12B, and 12C with fiber bodies 26D of varied lengths. Preform insert 12D can optionally include sheath 28D, represented with dashed lines in FIG. 3D. Sheath 28D can be substantially similar to sheath 28C. Preform insert 12D further includes sacrificial polymer yarns 30D disposed between adjacent fiber bodies 26D to maintain some spacing between adjacent fiber bodies 26D through the application of interface coating(s) to ensure more even deposition of such coating(s). In an exemplary embodiment, polymer yarns 30D can be PVA yarns. Polymer yarns 30D are thermally decomposed prior to matrix formation. Polymer yarns 30D can be incorporated into any of preform inserts 12A-12C.

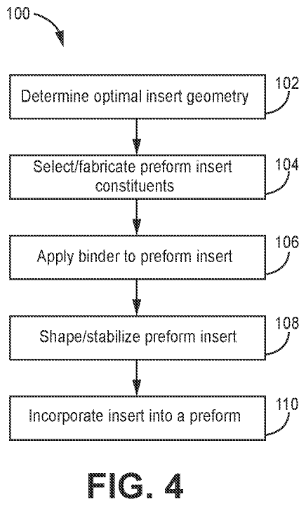

FIG. 4 is a method flowchart illustrating steps 102-110 of method 100 for fabricating a variable geometry space filling insert (e.g., insert 12). At step 102, the desired geometry of the insert for a particular void can be determined via experimentation and/or modeling based on the expected geometry of a preform void (e.g., void 20). At step 104, preform insert constituents can be fabricated and/or assembled. This includes the fabrication/selection of suitable fiber bodies via bundling, braiding, etc., then trimmed based on the desired geometry. A fabric sheath and/or polymer yarns, if desired for a particular preform insert, can also be fabricated. At step 106, a polymer binder can optionally be applied to any of the preform insert constituents to help stabilize the preform insert during processing. Exemplary binders can include solutions of polyvinyl alcohol (PVA) in water, or polyvinyl butyral (PVB) in an alcohol (e.g., ethanol) solvent, or other suitable solvent. The binder can further include inorganic particles, such as SiC or other ceramics. Such particles are intended to remain as part of the preform insert through matrix formation and help enhance matrix formation. In some embodiments, binder application can occur prior to any trimming performed in step 104. At step 108, preform insert constituents can be placed into a forming tool to help shape the preform insert. Additional amounts of polymer binder can be applied during step 108. Stabilization via heating with vacuum, mechanical compression and/or vacuum compression can also be carried out while preform insert is in the forming tool. At step 110, the shaped and/or stabilized insert can be removed from the forming tool, trimmed, if necessary, and incorporated into the preform. Depending on the preform, incorporation can include insertion into a void, laying up with additional plies, or three-dimensionally weaving the surrounding preform fabric around the insert.

A preform including one or more inserts 12 can subsequently undergo matrix formation and densification using a chemical vapor infiltration (CVI) process to form a CMC component. During densification, the braided layers 32 are infiltrated by reactant vapors, and a gaseous precursor deposits on the ceramic fibers. The matrix material can be SiC or other suitable ceramic material. Densification is carried out until the resulting CMC has reached the desired residual porosity. Interface coating(s) (e.g., of boron nitride-BN) can be deposited prior to the matrix to ensure that the composite fails in a non-brittle manner. In an alternative embodiment, densification can additionally and/or alternatively include other methodologies such as, but not limited to, melt infiltration (MI), slurry infiltration, and polymer infiltration and pyrolysis (PIP).

A CMC component formed with the disclosed space filling inserts can be incorporated into aerospace, maritime, or industrial equipment, to name a few, non-limiting examples.

### DISCUSSION OF POSSIBLE EMBODIMENTS

The following are non-exclusive descriptions of possible embodiments of the present invention.

A method of fabricating a variable geometry space filling insert for a ceramic matrix composite component includes arranging a plurality of fiber bodies into a preform insert, applying a polymer binder to the plurality of fiber bodies, trimming at least a first subset of the plurality of fiber bodies such that each of the first subset of fiber bodies is shorter than at least a second subset of fiber bodies, shaping the insert with a forming tool to form a shaped insert.

The method of the preceding paragraph can optionally include, additionally and/or alternatively, any one or more of the following features, configurations and/or additional steps:

In the above method, each of the plurality of fiber bodies can be formed from silicon carbide.

In any of the above methods, each of the plurality of fiber bodies can be a silicon carbide tow.

In any of the above methods, each of the plurality of fiber bodies can be a strand of braided tows.

Any of the above methods can further include incorporating a plurality of PVA yarns into the preform insert.

Any of the above methods can further include wrapping a fabric sheath around the plurality of fiber bodies.

In any of the above methods, the fabric sheath can include silicon carbide.

In any of the above methods, the polymer binder can include one of PVA and PVB.

In any of the above methods, the polymer binder can further include silicon carbide particles.

Any of the above methods can further include trimming a third subset of the plurality of fiber bodies such that each of the third subset of fiber bodies is shorter than the first subset and the second subset of fiber bodies.

Any of the above methods can further include stabilizing the preform insert in the forming tool using one or a combination of mechanical compression, vacuum, vacuum compression, and heat.

A method of forming a ceramic matrix composite component includes fabricating a variable geometry space filling insert using any of the above methods, incorporating the insert into a preform, and densifying the preform with a ceramic matrix.

In any of the above methods, the step of densifying the preform can include at least one of: chemical vapor infiltration, polymer infiltration and pyrolysis, melt infiltration, and slurry infiltration.

A variable geometry space filling insert for use in a ceramic matrix composite component includes a plurality of fiber bodies in a bundle, the bundle including a first subset of fiber bodies, and a second subset of fiber bodies, each being longer than each of the first subset of fiber bodies.

The insert of the preceding paragraph can optionally include, additionally and/or alternatively, any one or more of the following features, configurations and/or additional components:

In the above insert, each of the plurality of fiber bodies can be a silicon carbide tow.

In any of the above inserts, each of the plurality of fiber bodies can be a strand of braided tows.

In any of the above inserts, the bundle can further include a plurality of polymer yarns, the plurality of polymer yarns comprising polyvinyl alcohol.

Any of the above inserts can further include a third subset of fiber bodies, each being shorter than each of the first subset and second subset of fiber bodies.

Any of the above inserts can further include a fabric sheath wrapped around the bundle.

Any of the above inserts can further include silicon carbide particles.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of fabricating a variable geometry space filling insert for a ceramic matrix composite component, the method comprising:
arranging a plurality of fiber bodies into a preform insert;
applying a polymer binder to the plurality of fiber bodies;
trimming at least a first subset of the plurality of fiber bodies such that each of the first subset of fiber bodies is shorter than at least a second subset of fiber bodies; and
shaping the insert with a forming tool to form a shaped insert.

2. The method of claim 1, wherein each of the plurality of fiber bodies is formed from silicon carbide.

3. The method of claim 2, wherein each of the plurality of fiber bodies is a silicon carbide tow.

4. The method of claim 2, wherein each of the plurality of fiber bodies is a strand of braided tows.

5. The method of claim 1 and further comprising: incorporating a plurality of PVA yarns into the preform insert.

6. The method of claim 1 and further comprising: wrapping a fabric sheath around the plurality of fiber bodies.

7. The method of claim 6, wherein the fabric sheath comprises silicon carbide.

8. The method of claim 1, wherein the polymer binder comprises one of PVA and PVB.

9. The method of claim 8, wherein the polymer binder further comprises: silicon carbide particles.

10. The method of claim 1 and further comprising: trimming a third subset of the plurality of fiber bodies such that each of the third subset of fiber bodies is shorter than the first subset and the second subset of fiber bodies.

11. The method of claim 1 and further comprising: stabilizing the preform insert in the forming tool using one or a combination of mechanical compression, vacuum, vacuum compression, and heat.

12. A method of forming a ceramic matrix composite component, the method comprising:
fabricating a variable geometry space filling insert using the method of claim 1;
incorporating the insert into a preform; and
densifying the preform with a ceramic matrix.

13. The method of claim 12, wherein the step of densifying the preform comprises at least one of: chemical vapor infiltration, polymer infiltration and pyrolysis, melt infiltration, and slurry infiltration.

14. A variable geometry space filling insert for use in a ceramic matrix composite component, the insert comprising:
a plurality of fiber bodies in a bundle, the bundle comprising:
a first subset of fiber bodies; and
a second subset of fiber bodies, each being longer than each of the first subset of fiber bodies.

15. The insert of claim 14, wherein each of the plurality of fiber bodies is a silicon carbide tow.

16. The insert of claim 14, wherein each of the plurality of fiber bodies is a strand of braided tows.

17. The insert of claim 14, wherein the bundle further comprises: a plurality of PVA yarns.

18. The insert of claim 14 and further comprising: a third subset of fiber bodies, each being shorter than each of the first subset and second subset of fiber bodies.

19. The insert of claim 14 and further comprising: a fabric sheath wrapped around the bundle.

20. The insert of claim 14 and further comprising: silicon carbide particles.
